(19) United States
(12) Patent Application Publication
(10) Pub. No.: US 2012/0170966 A1
(43) Pub. Date: Jul. 5, 2012

(54) WRITING IMPLEMENT WITH STORAGE ENCLOSURE

(76) Inventor: JAMES RUSSELL NOVAK, JR., Redondo Beach, CA (US)

(21) Appl. No.: 13/342,164

(22) Filed: Jan. 2, 2012

Related U.S. Application Data
(60) Provisional application No. 61/429,449, filed on Jan. 3, 2011.

(51) Int. Cl. B43K 31/00; B43K 23/00

(52) U.S. Cl. 401/131

(57) ABSTRACT

A writing implement with storage enclosure disclosed is adapted for attaching to a surface of, or being integrated with, a range of objects for convenient access. The writing implement is length-compressible for compact retention in an associated storage enclosure, and extendable for greater ease of use. Retained in the storage enclosure, the top of the writing implement is flush, or nearly flush with the opening of the storage enclosure.

### CROSS-REFERENCE TO RELATED APPLICATIONS

This application claims the benefit of previously filed U.S. Provisional Patent Application No. 61/429,449, filed with the U.S. PTO on Jan. 3, 2011.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable.

### BACKGROUND

1. Field of the Invention

The present invention generally relates to the field of products for storing or holding writing implements. More particularly, the invention pertains to writing implements with accompanying storage enclosures for compact cooperative attachment to other objects.

2. Description of Related Art

Over the years, other efforts have been made to develop means for retaining a writing implement, be it a pen, pencil, stylus, marker, etc. Related art abounds with writing implements and holders or containers for them. A good number of examples of pertinent related art are set forth in this disclosure. Although others have invented products with methods of storing or holding a writing implement, various aspects of the writing implement with storage enclosure of the present invention surpass prior attempts by proving more convenient and effective at achieving the desired objectives.

Prior attempts of attaching writing implements to objects have included simple loops or clips, which often result in lost writing implements and subsequent difficulty in retrieving the writing implement. With the invention disclosed herein, it is much simpler to retrieve the writing implement, as only one hand is needed to retrieve the writing implement for use or replace it for storage. Many times, the proposed solution has been achieved by providing for addition of a simple clip to a writing implement. Other inventions have been directed to providing clamps for attaching a writing implement to a card edge, a pocket, or brim of a hat. Over the years, a number of attempts have been made to address these problems without success.

U.S. Pat. No. 1,728,128 issued Sep. 10, 1929 to Kodama, presents a pencil sheath pocket holder having a sheet-metal sheath and clip formed adjacent the sheath for gripping a pocket. The invention of Kodama primarily comprehends a sheath adapted for positioning within a garment pocket for receiving a pencil whereby to prevent casual displacement or loss of the same. Like many prior attempts to address this problem, Kodama simply provided a clip to secure a pencil holding tubular sheath.

U.S. Pat. No. 1,921,270, issued Aug. 8, 1933 to Talt, discloses a similar approach for holding a fountain pen. The main objects of the invention are to construct a sheath protector, which serves to replace the necessity of the pen cap and which permanently remains in the pocket. The protector sheath further provides a replaceable point wiping and fountain pen sealing device. Talt teaches use of a soft rubber cylinder as a liner for preventing the dropping of ink from the nib, but nonetheless suffers that same limited utility. The clip affixes via a small surface area while the sheath and pen project significantly beyond the attachment area and are increasingly prone to snagging on other objects.

U.S. Pat. No. 5,813,786, issued Sep. 29, 1998 to Fraenkel, discloses a writing instrument for securing a writing implement through incorporation of a clasping mechanism in the form of opposingly biased resilient jaws adapted for grasping a credit card or similar object having uniform thickness. Fraenkel teaches a writing instrument having means for detachably securing an article thereto. Such article may be a card, credit card, ID card, and the like. The writing instrument is fashioned in the form of a cylindrical casing, similar to that of a conventional pen, comprising a middle section in the form of a clasping mechanism for securing a card thereto and a cavity or bore longitudinally disposed within the casing for retaining a writing element. A fundamental disadvantage of the Fraenkel device is that the clamping mechanism remains attached to the writing instrument as a considerable obstruction that increases bulk and interferes with use.

U.S. Pat. No. 5,829,903, issued Nov. 3, 1998 to Collins, teaches a writing implement and cap therefore having an integral bookmark for retaining a writing implement in proximity to a book. The writing includes a corresponding cap adapted to be slidably received over the spine of a book wherein the blade portion of the cap extends downwardly between the pages of the book, and the body of the writing implement extends downwardly along the outside of the book spine. A significant disadvantage of the Collins inventions is that the ability of the retention mechanism to retain a writing implement is defeated upon opening the book.

U.S. Pat. No. 6,409,404, issued Jun. 25, 2002 to Piech, teaches a sheath for partially enclosing a ballpoint pen. The sheath provides storage means for a particularly configured, miniature ballpoint pen and employs adhesive mounting strip for securing the writing instrument to a chosen surface. The invention of Piech teaches a specially configured miniature pen composed of a rigid, thin, tubular writing cartridge and a sheath-like holder that has an adhesive mounting strip. The writing cartridge slides out of the sheath-like holder for usage. For storage, the writing cartridge slides into the sheath-like holder and rests snugly inside the sheath via a friction dimple. One side of the sheath-like holder possesses a strip of adhesive mounting tape. When mounting is desired, the thin protective cover is removed from the tape, thus exposing the adhesive, and the sheath is placed on the personal accessory. The miniature size of the pen and its pronounced end-cap protrusion of Piech provide significant obstacles to its utility.

U.S. patent application Ser. No. 12/437,807, by Hadden-Wight, and published Nov. 12, 2009 (Publication No. US 2009/0278344), discloses an enclosure for retaining a paper pad, electronic calculator, or such like hand-held device. The enclosure includes a recess adapted to receive a writing implement. When the front cover of the enclosure is closed, a writing implement is securely retained within the recess. When the cover is opened, the writing implement is moved to an accessible position for convenient access. The invention of Hadden-Wight provides additional bulk and complexity that reduce its usefulness and significantly increase cost.

For the foregoing reasons, there is a demonstrated need for a combination of writing implement with storage enclosure that provides the convenience of a writing implement in a compact and versatile storage device. Despite the previous attempts cited herein, none of the relevant art discloses a combination writing implement and storage enclosure as subsequently described and claimed.

### BRIEF SUMMARY OF THE INVENTION

As disclosed herein, the present invention relates to an extensible (compressible) writing implement with storage enclosure concept. This concept provides the user with a writing implement whenever needed, with the convenience of a compressed form (providing shortened length) for compact size and versatile placement wherever needed. Such writing implement provides an alternately compressible and extendable writing implement that is compressed for releasable retention in an aperture or cavity defined within a storage enclosure. User-actuated release of the actuation mechanism has the writing implement lengthen to facilitate its removal from the storage enclosure aperture. In an extended state, the writing implement is more comfortable to hold and easier to use. This is an improvement providing advantage and innovation with respect to previous writing implements holders.

The storage enclosure of the present invention is compact, low profile and unobtrusive. Incorporated into the binding of a book or attached to a desired surface, it is virtually unnoticeable. As the writing implement is inserted into the aperture of the storage enclosure, resistance encountered by the writing implement allows the user to compress the writing implement to a shortened, compressed state within the aperture and substantially flush with the storage enclosure surface.

A preferred embodiment has the storage enclosure of the present invention adapted to affix, either temporarily or permanently, to any of a number of common surfaces by way of various configurations. In such fashion, the writing implement is stored in a compressed state within a compact storage enclosure capable of convenient placement wherever a writing implement may be desired.

Another embodiment has the storage enclosure all the more versatile for its ability to be integrated with, or incorporated into the manufacture of, a great variety of products. During assembly of a book or notebook having a tape or similar binding, the storage enclosure can be incorporated in the binding assembly and overlaid by a cover. This provides a user with a pocketsize notebook with the storage enclosure integrated therein. When there arises the need to jot down a note, the user simply extends and withdraws the writing implement from the aperture (of the storage enclosure already integrated in the notebook binding) and everything needed for the task is immediately at hand: writing surface and a writing implement that is very difficult to lose or separate from the notebook.

A person often finds himself in a situation where he needs to jot down some kind of information. In many of these situations, he has also probably found himself looking for a piece of paper or pen or stylus. The consumer of today often has need for ready access to a writing implement. Despite this need, writing implements are not always readily or conveniently available. Many common writing implements do not fit conveniently in a pocket. Many shirts and other garments are more frequently constructed without suitable pockets. More and more people are not carrying a briefcase, purse, or planner. Even when a writing implement is provided for use, it is commonly left to roll around or slide off a table or tray. Whether one is a high-powered executive, blue-collar worker, student, or stay-at-home parent, there are often situations where it is necessary to jot down some kind of information. The writing implement with storage enclosure of the present invention provides a unique, compact, innovative, and functional device for numerous applications that effectively satisfy these needs.

The present invention secures and retains a writing implement and does so in compact form, thereby reducing the problem of losing the writing implement or of the writing implement becoming snagged or falling out of the storage enclosure. A compact and convenient aperture of the storage enclosure contains a writing implement in order that the potential for snagging or physical interference is virtually eliminated. When the user withdraws the writing implement, the compressed writing implement extends to provide greater ease of use.

Accordingly, the invention described herein seeks to provide a convenient, compact-yet-extendable writing implement in combination with associated storage enclosure for versatile attachment, that overcomes the problems and deficiencies with prior attempts and which provides a writing implement with storage enclosure which can be conveniently adapted to a wide range of applications.

In view of the foregoing, the present invention provides a new and innovative writing implement with storage enclosure allowing convenient, compact, and versatile attachment to various surfaces or objects benefiting from improved availability of a writing implement, or integration into the construction of an object itself.

The device of the present invention overcomes the limitations and deficiencies present in prior attempts of others by providing a compact, convenient writing implement with storage enclosure which allows the writing implement portion to be fully, or nearly fully, contained by the storage enclosure while providing convenient, one-handed removal and replacement of the writing implement portion. This unique construction provides for a wide range of novel and useful applications. Other objects and advantages of the present invention will become obvious to the reader and it is intended that these objects and advantages are within the scope of the present invention.

These and other features, aspects, and advantages of the present invention will become better understood with reference to the following description and claims. There has thus been outlined, rather broadly, the more important features of the invention in order that the detailed description thereof may be better understood, and in order that the present contribution to the art may be better appreciated. There are additional features of the invention that will be described hereinafter.

### BRIEF DESCRIPTION OF THE DRAWINGS

To the accomplishment of the above and related objects, this invention may be embodied in the form illustrated in the accompanying drawings, attention being called to the fact, however, that the drawings are illustrative only and that changes may be made in the specific construction illustrated.

Other objects and advantages of the invention will appear from the following description taken in connection with the appended drawings, in which like reference characters designate the same or similar parts throughout the several views, and wherein:

FIG. 1 is a side elevation view of a writing implement with storage enclosure constructed in accordance with the present invention, the writing implement shown partially inserted in the storage enclosure;

FIG. 2 is a side elevation view of the storage enclosure portion of the writing implement with storage enclosure of FIG. 1; phantom lines indicate aspects of storage enclosure aperture or cavity;

FIG. 3 is a perspective end view of the storage enclosure of FIG. 1;

FIG. 4 is a perspective view of a writing implement of the device of FIG. 1, in an extended or uncompressed state;

FIG. 5 is a perspective view of a writing implement of the device of FIG. 1, in a contracted or compressed state;

FIG. 6 is a perspective view of a writing implement with storage enclosure in accordance with the present invention, depicting a writing implement inserted into an aperture of the storage enclosure with the writing implement in a partially extended or uncompressed state;

FIG. 7 is a perspective view of a writing implement with storage enclosure in accordance with the present invention, depicting the writing implement inserted in the aperture defined by the storage enclosure with the writing implement in a contracted or compressed state;

FIG. 8 is a perspective view of the storage enclosure portion of the writing implement with storage enclosure of FIG. 1 and with writing implement removed;

FIG. 9 is a perspective view of an alternative embodiment of the writing implement with storage enclosure, having curved sides and depicting comparative views of the writing implement inserted in the storage enclosure aperture in both a contracted or compressed state with writing implement flush or nearly flush with storage enclosure and, an extended state with the writing implement protruding partially from storage enclosure to assist ease of removal;

FIG. 10 is a perspective phantom view of the alternative embodiment of FIG. 9 from an opposite perspective, depicting the writing implement inserted in the storage enclosure aperture both in compressed and extended states, demonstrating the different states of length of the writing implement;

FIG. 11 is a perspective view of a notebook or book having the writing implement with storage enclosure of FIG. 1 integrated into the binding assembly and depicting the writing implement inserted in the storage enclosure both in contracted and extended states;

FIG. 12 is a perspective phantom view of the notebook embodiment of FIG. 11, depicting the writing implement inserted in the storage enclosure both in contracted and extended states.

### DETAILED DESCRIPTION OF THE INVENTION

The writing implement with storage enclosure of the present invention is capable of alternative embodiments and of being practiced and applied in various ways. Also, it is to be understood that the phraseology and terminology employed herein are for the purpose of the description and should not be regarded as limiting. In this respect, before explaining at least one embodiment of the invention in detail, it is to be understood that the invention is not limited in its application to the details of construction and to the arrangements of the components set forth in the following description or illustrated in the drawings. In other instances, procedures, parts, and methods known to persons skilled in the art have not been set forth in detail to avoid undesired obfuscation of the particular characteristics, benefits, and other aspects of the present invention.

The present invention is directed toward a writing implement with storage enclosure for attaching to a surface or integrating with, an object or consumer article. More specifically, the writing implement of the present invention is able to compress in length for retention in the storage enclosure, and extend in length for greater ease of use. Retained by the storage enclosure, the top of the writing implement is flush or nearly flush, with the opening of the aperture or cavity within the storage enclosure. History is replete with holders for writing implements that fail to address a persistent deficiency. By not concealing substantially all of the writing implement, previous holders allow a significant portion of the writing implement to extend beyond the holder device. The resulting projection of the writing implement from prior art holders makes the writing implement very prone to snagging. The projecting writing implement transfers significant, and potentially damaging, force to the holder device. An object of the present invention negates the risk of snagging and overcomes the limitations of prior art holders. Another object is to provide a compact storage enclosure for versatile attachment to a range of objects. Another object of the present invention is to provide compact writing implement storage adapted for integration with books, notebooks, pads, etc.

Reference is now made to the accompanying drawing sheets and their figures. From figure to figure, like reference numerals refer to and correspond with like elements. Even though the drawing sheets and figures present various aspects of the embodiments depicted, the figures are not necessarily drawn to scale. Persons skilled in the art will recognize that the systems and methods disclosed herein may be practiced without one or more of the specific details, or with other methods, components, materials, etc. In some instances, well-known structures, materials, or operations are not shown or described in detail. The described features, structures, or characteristics may be combined in any suitable manner in one or more embodiments. It is also readily understood that components of the embodiments, as generally described and illustrated in the figures herein, could be arranged and designed in a wide variety of different configurations. For this application, the phrases “connected to” and “coupled to” are used to refer to any form of interaction between two or more entities, including mechanical, magnetic, or other interaction. Two components may be coupled to each other even though they are not in direct contact with each other.

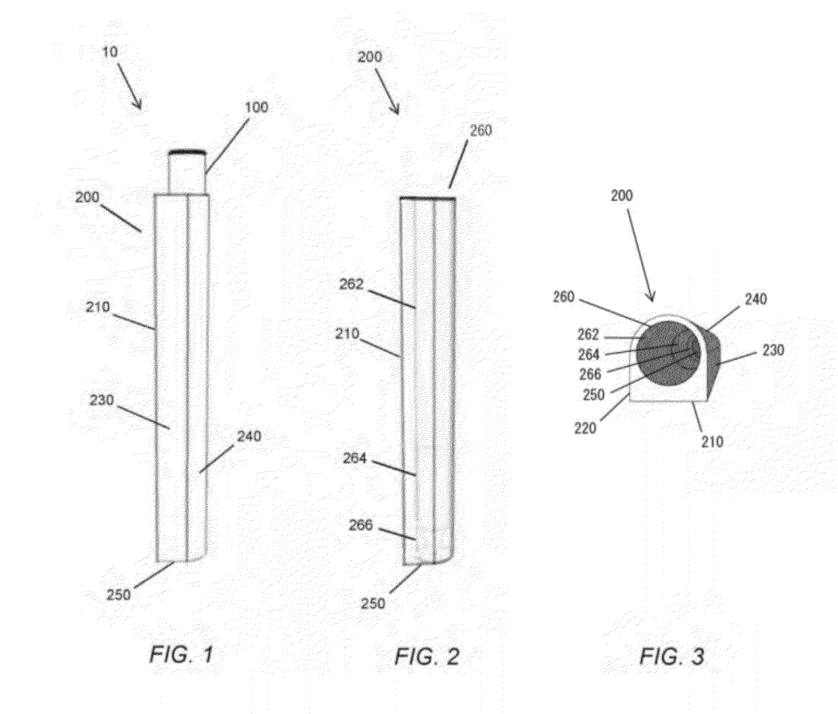

Turning now to the drawings, the accompanying FIGS. 1-12 illustrate a writing implement with storage enclosure in accordance with the present invention.

Referring now to FIG. 1, an embodiment of a writing implement with storage enclosure 10 in accordance with the present invention includes a storage enclosure 200 for releasable retention of writing implement 100. Writing implement 100 is depicted partially extending from an aperture or cavity formed 260 within storage enclosure 200, awaiting further insertion or removal for use. The upper end of writing implement 100 is extended and visible. When extended as shown, writing implement 100 is exposed and positioned for grasping and subsequent removal by a user, or for further insertion to achieve secure retention and storage. Storage enclosure 200 is constructed of plastic, silicone, metal, or other suitable material or combination of materials providing desired characteristics. Injection molded pieces or extruded shapes are preferred. Storage enclosure 200 has a flat first side 210, adapted for attaching or mounting to a desired surface of an object. In one embodiment, flat first side 210 is equipped with adhesive for attachment to a desk or other surface. Other contemplated embodiments provide convenient attachment through incorporation of hook and loop fastenings, magnets or magnetic strips, or a variety of clips. Storage enclosure 200 has a second side 220 and a third side 230 positioned opposite and adjacent flat first side 210. Second side 220 is not visible in FIG. 1 but is depicted in FIG. 3. Fourth side 240 is located adjacent and between second side 220 and third side 230. Flat first side 210, second side 220, third side 230, and fourth side 240 collectively constitute a perimeter of storage enclosure 200. End panel 250 adjoins flat first side 210, second side 220, third side 230, and fourth side 240 to form a closed bottom panel of storage enclosure 200. Storage enclosure 200 defines aperture 260 (indicated in FIG. 2), having a generally cylindrical inner surface or cavity. Said aperture 260 is aligned axially parallel to the longer axis of storage enclosure 200, within the perimeter created by flat first side 210, second side 220, third side 230, and fourth side 240. In the preferred embodiment depicted in FIG. 1, second side 220 and third side 230 are each flat or planar, and fourth side 240 constitutes a curved surface adjoining second side 220 and third side 230.

FIG. 2 depicts a storage enclosure 200 of the preferred embodiment, with aperture 260 defined axially therein. Aperture 260 affords an upper section 262, and a lower section 264 adjacent said upper section 262, adapted for guiding and securing writing implement 100. Upon insertion into said aperture 260, said writing implement 100 interacts with said aperture or said end panel 250 to provide resisting force sufficient to transition said writing implement 100 to a compressed state for compact storage with writing implement 100 substantially flush within said aperture 260. In a preferred embodiment, lower section 264 is adjacent a shaped and generally tapered region 266 for guiding and holding a writing implement 100 in releasable retention through friction. The surface of aperture 260 and accordingly, upper section 262, lower section 264, and tapered region 266, preferably incorporates flexible or compressible materials adapted and dimensioned to provide frictional retention of writing implement 100 within storage enclosure 200. Retention of the writing implement 100 within aperture 260 of the storage enclosure 200 is achieved through arrangements for mechanical engagement, magnetic attraction, friction, or other suitable force. When the tip contacts the remote end panel 250 of aperture 260 of storage enclosure 200, or contacts portions of said aperture 260 having lesser diameter, resistance is encountered which facilitates the transition of the extensible portion mechanism of writing implement 100 to a contracted, or compressed, mode. While the user is pushing the writing implement 100 down, the writing implement 100 will be forced into the reduced diameter lower section 264 of aperture 260 of the storage enclosure 200. This ensures the writing implement 100 will not move or fall out, but only come out when the user repeats the process to retrieve the writing implement 100 as described above. The smaller diameter lower section 264 is supplemented by a tapered region 266 for holding writing implement 100 in secure retention in a manner rather similar as a pen cap for a pen. It is snug enough to fit around the tip of the writing implement 100 and will not move until the user applies force when removing the writing implement 100 from aperture 260 of storage enclosure 200.

FIG. 3 depicts a perspective view of storage enclosure 200, generally along a longitudinal axis of aperture 260. Within aperture 260 are depicted upper section 262, lower section 264, and tapered region 266, along with end panel 250 of storage enclosure 200. Aperture 260 provides such sections or regions along its length, with each adapted variously to facilitate guiding and retaining of a writing implement 100 within a storage enclosure 200. Depicted is a preferred arrangement and configuration of storage enclosure 200 with flat first side 210, second side 220 and third side 230 adjoining opposite edges of flat first side 210, with fourth side 240 adjoining and curvedly spanning between of second side 220 and third side 230. The construction of storage enclosure 200, particularly with respect to aperture 260, preferably incorporates pliable material that flexes under force, as during insertion and retention of the writing implement 100, but returns to its original shape when such force is removed. The material may also exhibit moderate-to-strong frictional resistance to retain a grip on the inserted writing implement 100.

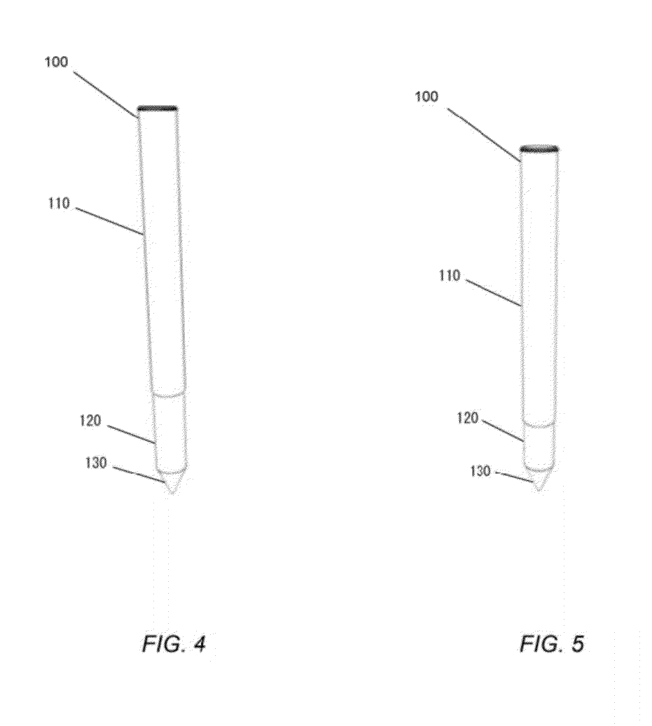

FIGS. 4 & 5 depict writing implement 100 with the compressible-extendable feature that contributes to the ability of the present invention to meet the desired objective. The compressible-extendable feature enables writing implement 100 to be retained in aperture 260 with top of writing implement 100 flush with storage enclosure 200, while providing the ability to extend in length for removal from the storage enclosure 200 and aperture 260 for convenient use. Writing implement 100 provides a user-actuated extension mechanism adapted to provide a compressible and extendable function of upper actuator portion 110 and lower body portion 120 of writing implement 100. Lower body portion 120 retains a selected writing cartridge 130 for desired marking ability. FIG. 4 depicts writing implement 100 in an extended or uncompressed state. FIG. 5 depicts writing implement 100 in a compressed or contracted state, with upper actuator portion 110 and lower body portion 120 providing greater overlap and associated reduction in length of writing implement 100. Upon actuation by a user, writing implement 100 extends, urging upper actuator portion 110 away from lower body portion 120 to an extended or uncompressed state, and protruding upper actuator portion 110 from cylindrical aperture 260 of storage enclosure 200, thereby allowing retrieval of writing implement 100 and its subsequent removal from cylindrical aperture 260.

Writing implement 100 has two states: contracted and extended. In the contracted (or compressed) state, writing implement 100 is contained inside storage enclosure 200 with all but the top of writing implement 100 within storage enclosure 200. Writing implement 100 is flush or nearly flush with the top of the storage enclosure 200. To remove the writing implement from the storage enclosure, a user extends the writing implement 100 to convert the writing implement 100 from the contracted state to the extended state. This state-converting mechanism is achieved by a variety of adaptations known in the art. Writing implement 100 is adapted to compress along its length when inserted into the storage enclosure 200 for retention and storage by a user. Accordingly, the writing implement 100 is adapted to extend for removal from the storage enclosure 200 and subsequent use. The compressible-extendable function of writing implement 100 is achieved through incorporation of one of a number of means including, but not limited to telescoping, a “push-push” or pop-up mechanism, or otherwise readily extendible configuration to facilitate ease of removal from the storage enclosure 200 and to provide a compact-but-extendable device for convenient writing.

A variety of methods for achieving a compressible-extendible writing implement will be familiar to those skilled in the art. Prior attempts have addressed expandable writing instruments, as in the U.S. Pat. No. 6,273,627, issued Aug. 14, 2001, to Mittersinker et al. Rather straightforward telescopic pens have been described in U.S. Pat. No. 6,474,889, issued Nov. 5, 2002, to Kato, and U.S. Pat. No. 6,616,365, issued Sep. 9, 2003 to Vann. The inventions describe some of the many methods in which a compressible-extendible writing implement may be achieved. The first objective is the ability to lengthen and shorten as needed for storage in the storage enclosure 200. Additional benefits are realized by having writing implement 100 allow for user activation or actuation of the lengthening of the writing implement One example of such function and design is disclosed in U.S. Pat. No. 6,832,868, issued Dec. 21, 2004 to Hertwig et al. The Hertwig '868 patent describes a writing implement that converts between a first position in which the writing cartridge protrudes from the housing for writing, and a second position in which the cartridge is retracted into the housing. In the first position the writing implement has a total length suitable for writing, and in the second position the writing implement is contracted. The writing implement can be brought into the writing position and also extended in a single hand movement. To achieve this the implement is provided with a depressor configured as an extension of the housing and can be actuated to move the writing cartridge between the first and second positions, and which in the first position extends out from the rear end of the housing.

A compressible-extendable length function allows the writing implement with storage enclosure 10 of the present invention to be incorporated into books, notebooks, notepads, and similar objects that might otherwise be too small to conveniently retain a writing implement. The writing implement 100 may be stored in the storage enclosure 200, and retained by the size, shape, and structure of the storage enclosure aperture 260. Materials providing frictional, magnetic, or other retention forces are incorporated in construction of the storage enclosure 200 and aperture 260 to enable secure storage and retention of writing implement 100.

In one configuration, a “push-push” (or eject-type latch) mechanism is provided. Such mechanism is incorporated to provide a “push-retain and push-release” feature for retaining the writing implement 100 with the storage enclosure 200. Such push-push mechanisms are widely used in cabinet hardware, electronic devices, and well known to those skilled in the art. The writing implement 100 is retained in the storage enclosure 200 for secure and convenient retention. When the writing implement 100 is “pushed” (depressed), a push-push mechanism releases and causes upper portion 110 of writing implement 100 to partially extend beyond the storage enclosure 200, thereby allowing a user to grasp and withdraw writing implement 100 from storage enclosure 200. When re-inserted and pushed (compressed or depressed) into the storage enclosure 200, the writing implement 100 is again secured and retained within the storage enclosure portion by retention force.

Examples of such push-push mechanisms and associated applications may be found in U.S. Pat. No. 5,507,423, issued Apr. 16, 1996 to Fischer et al.; U.S. Pat. No. 6,739,633, issued May 25, 2004 to Holloway et al.; and U.S. patent application Ser. No. 12/874,229 of Lin, published Jun. 23, 2011 (Pub. No.: US 2011/0148019). The present invention incorporates a push-push or similar mechanism for providing extendable features to writing implement 100. Through incorporation of mechanisms or methods described or known to those skilled in the art, such mechanism is integrated within writing implement 100, whereby it is adapted to extend for use.

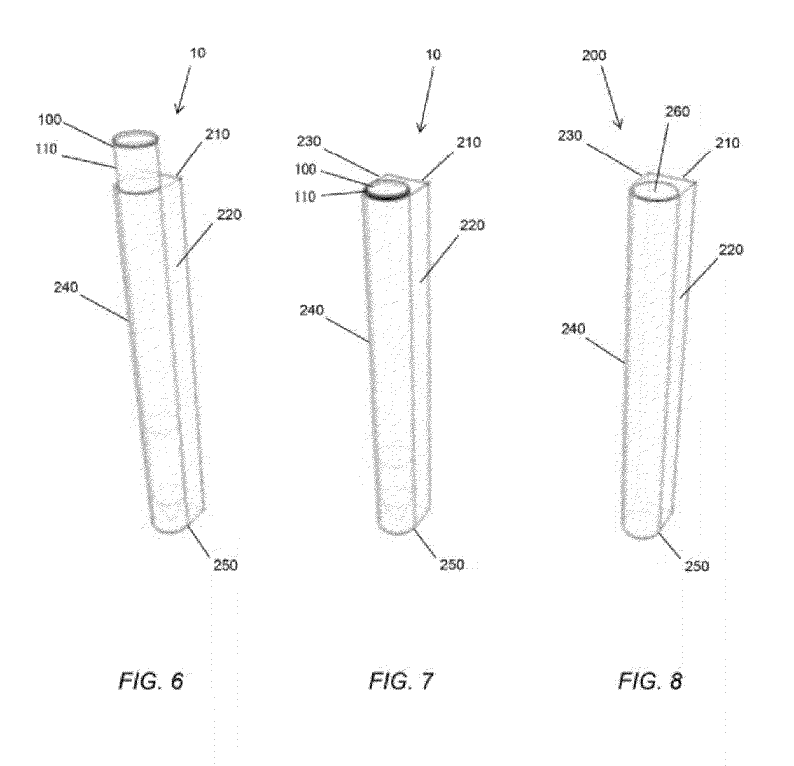

FIG. 6 depicts storage enclosure 200 with writing implement 100 protruding partially from aperture 260 in a partially extended or uncompressed state by way of a mechanism for extension. The user depresses the visible portion of the writing implement 100, shown in FIG. 6 protruding from aperture 260 to compress writing implement 100 to a compressed state for storage.

FIG. 7 depicts writing implement 100 in the contracted or compressed state for retaining in aperture 260 of storage enclosure 200. When retained by storage enclosure 200 for storage, writing implement 100 is substantially contained within aperture 260, in that the top upper actuator portion 110 of writing implement 100 is flush or nearly flush with the top of storage enclosure 200. To remove writing implement 100, the user actuates the push-push or other mechanism adapted to extend the writing implement 100, preferably by depressing the top of upper actuator portion 110 of writing implement 100, thereby causing upper actuator portion 110 of writing implement 100 to partially protrude from aperture 260 to enable a user to grasp and remove writing implement 100 for use.

FIG. 8 depicts storage enclosure 200, having writing implement 100 removed. Flat first surface 210 is adapted for affixing to the exterior or other surface of a broad range of objects. One of a variety of mechanisms may be selected for affixing the storage enclosure 200 in a desired location, either releasably or permanently. “Pen-clip” style adapters allow the writing implement with storage enclosure 10 of the present invention to be attached to shirt or pants pockets, belts, glasses cases, mobile phone cases, books, notebooks, notepads, automobile visors, etc. One or more such pen-clips can be attached to a storage enclosure 200 that can then be inserted into the binding of a spiral bound notebook. One or more “alligator” or similar clips attached to storage enclosure 200 allow the storage enclosure 200 to be clipped into shirt or pants pockets, belts, glasses cases, cell phone cases, books, notebooks, notepads, automobile visors, etc. Clips adapted to attach to automobile air vent enable the storage enclosure 200 to be attached to a car vent for secure transport. Magnets or magnetic strips allow storage enclosure 200 to be attached to metal surfaces such as refrigerators, file cabinets, etc. Materials providing high friction coefficient in conjunction with the present invention allow storage enclosure 200 to resist movement when placed on surfaces such as an automobile dashboard, an angled artist's or architect's table, etc. For example, silicone or acrylic rubbers are candidates. Non-skid, or no-slip, materials such as grip tape, or non-permanent adhesive, may be similarly applied.

Hook and loop fastenings enable the storage enclosure 200 to be attached to a wide range of surfaces in a releasable and repeatedly attachable manner. (A well-known manufacturer of many varieties of hook and loop fabric fastening materials is Velcro USA of Manchester, N.H.) A partial list of desirable locations and surfaces for affixing or mounting the writing implement with storage enclosure 10 of the present invention includes automobile consoles or dashboards, office or other desks, the interior of a briefcase, a cover of a notebook or book, etc. The storage enclosure 200 is able to provide different shapes or profiles for different applications. Flat first side 210 is adapted for attaching to a surface for mounting. Second side 220, third side 230, and fourth side 240 are varied to provide an exterior profile most suitable for the desired application. Storage enclosure 200 defines aperture 260, having a generally cylindrical cross-section and adapted to receive writing implement 100. The dimensions of the generally cylindrical aperture 260 defined by the storage enclosure 200 are appropriate to retain the writing implement through friction or other retention force. In one embodiment, the walls or surfaces of aperture 260 afford sections of lesser diameter along the long axis of aperture 260 for guiding the writing implement into aperture 260 of storage enclosure 200 and retaining through frictional contact. Suitable materials for such retention are contemplated for at least portions of inner surfaces of aperture 260. Aperture 260 of storage enclosure 200 provides resiliency and flexibility for frictional retention of the writing implement. The cylindrical aperture size is adapted to provide frictional engagement for releasably retaining and securing writing implement 100.

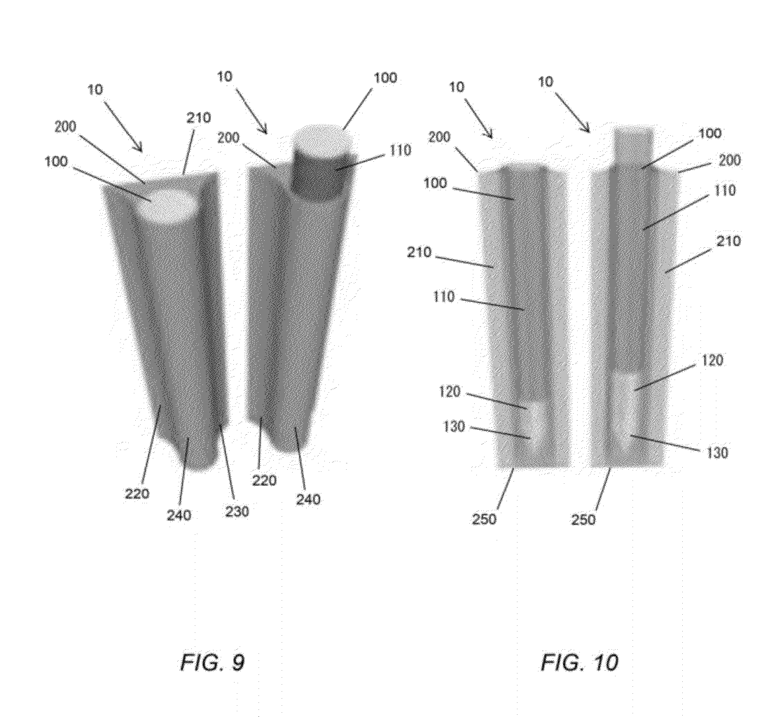

Referring now to FIG. 9, depicted are two views of an alternative embodiment of the present invention, with a first view depicting writing implement 100 in storage enclosure 200 in the compressed state. A second view depicts writing implement 100 in the extended state. Flat first side 210 is adapted for attaching to a surface for mounting. Storage enclosure 200 is attachable to a wide range of products from books, notebooks, and portfolios to wallets, glasses cases, and mobile phone cases. Second side 220 and third side 230 are shaped to achieve a more visually appealing profile. A wide range of such variations is contemplated to suit the desired application.

FIG. 10 depicts storage enclosure 200 with partial phantom view, to better visualize writing implement 100 in both contracted and extended states.

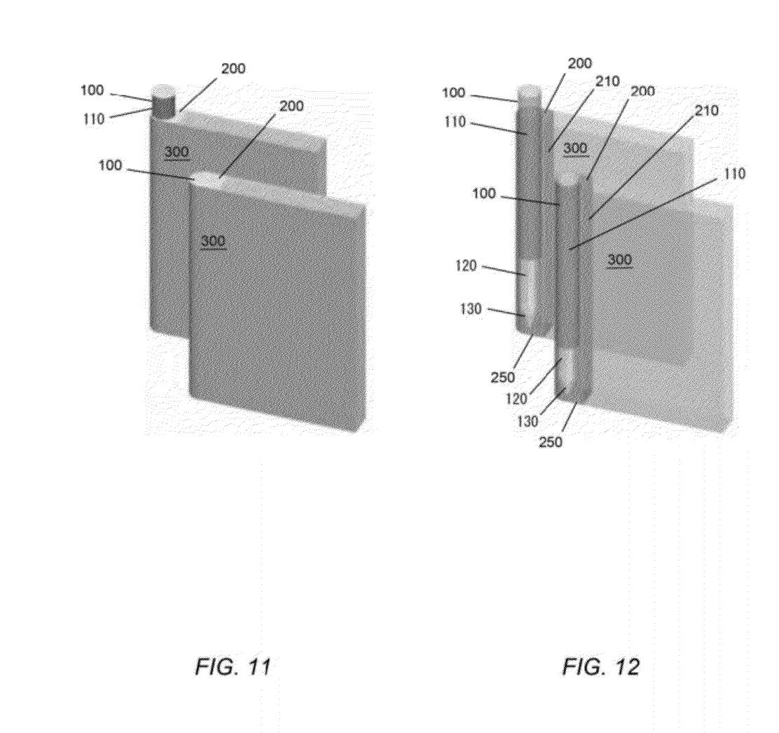

Referring now to FIG. 11, in an alternative embodiment, storage enclosure 200 is engineered to be integral with a wide range of utilitarian objects, such as a book, notepad, portfolio, clipboard, binder, or tablet. By way of such integration in design and manufacture, storage enclosure 200 may be almost entirely concealed within the spine, edge, or binding of a book, folder, tablet, pad, or notebook 300. Other objects accommodate the present invention to increase convenience and use; a partial list includes calendars, day planners, binders, clipboards, portfolios, restaurant bill presenters, clutches, wallets, and truckers and pilot log-books, etc. The storage enclosure 200 affixes to the binding of a notebook 300 having a tape binding. The user can carry around a pocket-size notebook 300 incorporating the writing implement with storage enclosure of the present invention and when he needs to jot down a note, he simply pulls out the notebook and has everything he needs: paper and a writing implement that is very difficult to lose or separate from the notebook. Aperture 260 of storage enclosure 200 is preferably cylindrical and diameter-adapted to receive the writing implement 100. When inserted into aperture 260 of storage enclosure 200, the writing implement 100 is retained preferably by friction. The exterior of storage enclosure 200 is molded to afford a constant profile along its long axis.

FIG. 12 depicts writing implement 100 and storage enclosure 200 in partial phantom view, so as to better visualize writing implement 100 in both contracted and extended states within storage enclosure 200. The writing implement with storage enclosure 10 of the present invention is readily integrated with binding methods commonly used in publishing and known to those skilled in the art. The storage enclosure portion is adhered to the tape binding of a notebook 300 and a cover is placed over both the storage enclosure and the notebook. Using the “perfect bound” binding technique, having a card-stock spine and cardboard for stiffening the covers, a book or notebook 300 is constructed with a flat side of the storage enclosure portion affixed to the card-stock spine prior to a cover being placed over the book. The storage enclosure 200 is also adapted for stitching into a finished product. The storage enclosure 200 is integrated (via stitching) in the spine or exterior surface of the spine of a leather portfolio, book cover, wallet, or other useful product. For molded or plastic articles, the storage enclosure 200 of the present invention is incorporated integrally with injection or other molding processes to create consumer products with exceptional convenience and innovation. These and other binding methods are known to those skilled in the art and are considered within the scope of methods considered adaptable to integration of the storage enclosure 200 for practice of the present invention.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and within the understanding of one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, being within the scope of the invention.

What is claimed is:

1. A writing implement with storage enclosure for compact storage and releasable retention of an extendable writing implement having a selectable, compact, first shortened state and a second extended state suited for writing by a user, comprising:
a writing implement having
a writing cartridge operably arranged within
a lower body portion, and
an upper actuator portion in longitudinal telescopic relation to said lower body portion, adapted for selectable actuation of said writing implement from a first shortened state suited for compact storage to a second extended state suited for writing by a user,
a storage enclosure having
a flat first side adapted for attachment to a surface,
a second side adjoining said flat first side, and
a third side adjoining said flat first side opposite said second side,
a fourth side adjacent and connecting said second side and said third side,
an end panel adjoining said flat first side, said second side, said third side, and said fourth side in perimeter connection,
said storage enclosure further defining an aperture for receiving said writing implement, said aperture having a generally cylindrical inner surface extending lengthwise a substantial portion of the length of said storage enclosure and aligned axially parallel to the longitudinal axis of said storage enclosure, said aperture adapted to receive and retain said writing implement with said lower body portion and said writing cartridge fully enclosed within said aperture with said upper actuator portion substantially flush with said aperture for storage in a first shortened state of said writing implement,
wherein said upper actuator portion of said writing implement partially extends from said aperture upon selectable actuation by a user from a first shortened state to a second extended state, thereby facilitating removal of said writing implement from said aperture by a user.

2. The writing implement with storage enclosure of claim 1, wherein said aperture incorporates flexible or compressible materials adapted and dimensioned to provide frictional retention of said writing implement within said storage enclosure.

3. The writing implement with storage enclosure of claim 1, wherein said writing implement is retained in said aperture with mechanical engagement.

4. The writing implement with storage enclosure of claim 1, wherein said writing implement is retained in said aperture with magnetic force.

5. The writing implement with storage enclosure of claim 1, wherein said flat first side of said storage enclosure is adapted for attachment to a surface with adhesive.

6. The writing implement with storage enclosure of claim 1, wherein said flat first side of said storage enclosure is adapted for attachment to a surface with at least one clip.

7. The writing implement with storage enclosure of claim 1, wherein said flat first side of said storage enclosure is adapted for attachment to a surface with magnetic force.

8. The writing implement with storage enclosure of claim 1, wherein said flat first side of said storage enclosure is adapted for attachment to a surface with hook and loop fastenings.

9. The writing implement with storage enclosure of claim 1, wherein said flat first side of said storage enclosure is adapted for attachment to a surface with high friction coefficient material.

10. The writing implement with storage enclosure of claim 2, wherein said aperture comprises at least one section of lesser diameter along the long axis adapted to guide said writing implement and enable retention within said aperture through friction.

11. The writing implement with storage enclosure of claim 10, wherein said aperture at least one section of lesser diameter further comprises an upper section and a lower section for guiding and retaining said writing implement.

12. The writing implement with storage enclosure of claim 11, wherein said lower section further comprises a tapered region shaped for guiding and retaining said writing implement.

13. The writing implement with storage enclosure of claim 1, wherein said storage enclosure is constructed of plastic, silicone, metal, or other suitable material or combination of materials.

14. The writing implement with storage enclosure of claim 1, wherein said second side and said third side are generally planar, with said fourth side providing a curved surface adjoining said second side and said third side.

15. The writing implement with storage enclosure of claim 1, wherein said second side, said third side, and said fourth side are varied in shape to provide a desired exterior profile of said storage enclosure.

16. A writing implement with storage enclosure for compact storage and releasable retention of an extendable writing implement having a selectable, compact, first shortened state and a second extended state suited for writing by a user, comprising:
a writing implement having
a writing cartridge operably arranged within
a lower body portion, and
an upper actuator portion in longitudinal telescopic relation to said lower body portion, adapted for selectable actuation of said writing implement from a first shortened state suited for compact storage to a second extended state suited for writing by a user,
a storage enclosure having
a flat first side adapted for attachment to a surface,
a second side adjoining said flat first side, and
a third side adjoining said flat first side opposite said second side,
a fourth side adjacent and connecting said second side and said third side,
an end panel adjoining said flat first side, said second side, said third side, and said fourth side in perimeter connection,
wherein said flat first side, said second side, said third side and said fourth side are adapted for integration with manufactured articles,
said storage enclosure further defining an aperture for receiving said writing implement, said aperture having a generally cylindrical inner surface extending lengthwise a substantial portion of the length of said storage enclosure and aligned axially parallel to the longitudinal axis of said storage enclosure, said aperture adapted to receive and retain said writing implement with said lower body portion and said writing cartridge fully enclosed within said aperture and said upper actuator portion positioned substantially flush with said aperture for storage in a first shortened state,
wherein said upper actuator portion of said writing implement partially extends from said aperture upon selectable actuation by a user from a first shortened state to a second extended state, thereby facilitating removal of said writing implement from said aperture by a user.

17. The writing implement with storage enclosure of claim 16, wherein said aperture incorporates flexible or compressible materials adapted and dimensioned to provide frictional retention of said writing implement within said storage enclosure.

18. The writing implement with storage enclosure of claim 16, wherein said writing implement is retained in said aperture with mechanical engagement.

19. The writing implement with storage enclosure of claim 16, wherein said writing implement is retained in said aperture with magnetic force.

20. The writing implement with storage enclosure of claim 16, wherein said storage enclosure is adapted for integration with a binding or spine of an article.

21. The writing implement with storage enclosure of claim 20, wherein said storage enclosure is adapted for integration with an object having a stitched binding.

22. The writing implement with storage enclosure of claim 20, wherein said storage enclosure is adapted for integration with an object having a tape binding.

23. The writing implement with storage enclosure of claim 20, wherein said storage enclosure is adapted for integration with an object having a perfect-bound binding.

24. The writing implement with storage enclosure of claim 17, wherein said aperture comprises at least one section of lesser diameter along the long axis adapted to guide said writing implement and enable retention within said aperture through friction.

25. The writing implement with storage enclosure of claim 24, wherein said aperture at least one section of lesser diameter further comprises an upper section and a lower section for guiding and retaining said writing implement.

26. The writing implement with storage enclosure of claim 25, wherein said lower section further comprises a tapered region shaped for guiding and retaining said writing implement.

27. The writing implement with storage enclosure of claim 16, wherein said storage enclosure is constructed of plastic, silicone, metal, or other suitable material or combination of materials.

28. The writing implement with storage enclosure of claim 16, wherein said second side and said third side are generally planar, with said fourth side providing a curved surface adjoining said second side and said third side.

29. The writing implement with storage enclosure of claim 16, wherein said second side, said third side, and said fourth side are varied in shape to provide a desired exterior profile of said storage enclosure.

30. In a writing implement with storage enclosure adapted for integration within an object and for releasable retention of an extendable writing implement having a first shortened state and a second extended state, the writing implement with storage enclosure comprising:
an extendable writing implement,
a storage enclosure having
a flat first side adapted for integration within binding and cover assemblies, and
an aperture for receiving said extendable writing implement, said aperture defined generally cylindrically and extending lengthwise a substantial portion of the length of said storage enclosure, aligned axially parallel to the longitudinal axis thereof, having compressible material incorporated with an inner surface of said aperture, and
a plurality of sections of lesser diameter adapted for guiding and retaining said extendable writing implement,
said aperture further dimensioned to receive, substantially flush within said aperture, said extendable writing implement in a first shortened state, and
wherein said extendable writing implement partially protrudes from said aperture in a second extended state, facilitating removal.
